(19) United States
(12) Patent Application Publication
(10) Pub. No.: US 2015/0055072 A1
(43) Pub. Date: Feb. 26, 2015

(54) LIQUID CRYSTAL DISPLAY PANEL

(71) Applicant: InnoLux Corporation, Miao-Li County (TW)

(72) Inventors: Bo-Chin TSUEI, Miao-Li County (TW); Jian-Cheng CHEN, Miao-Li County (TW); Chih-Yung HSIEH, Miao-Li County (TW)

(21) Appl. No.: 14/465,386

(22) Filed: Aug. 21, 2014

Related U.S. Application Data
(60) Provisional application No. 61/869,304, filed on Aug. 23, 2013.

(30) Foreign Application Priority Data
Nov. 19, 2013 (TW) 102142038

(51) Int. Cl. G02F 1/1337; G02F 1/1343

(52) U.S. Cl. CPC G02F 1/1337; G02F 1/134336; G02F 1/133788
USPC 349/128

(57) ABSTRACT

A liquid crystal display (LCD) panel includes a plurality of pixel units, a first alignment layer and a second alignment layer. The pixel units are configured in a matrix formed by columns and rows, and each pixel unit is divided into a plurality of domains. The alignment direction of the first alignment layer is parallel to the column direction, while the alignment direction of the second alignment layer is parallel to the row direction. The domains of the pixel units have different tilt directions for liquid crystal molecules defined by the first and second alignment layers. In two adjacent pixel units arranged in the row direction, the domains adjacent to a boundary between the two adjacent pixel units have the same tilt direction for liquid crystal molecules defined by the first and second alignment layers.

### CROSS REFERENCE TO RELATED APPLICATIONS

The non-provisional patent application claims priority to U.S. provisional patent application with Ser. No. 61/869,304 filed on Aug. 23, 2013 and under 35 U.S.C. §119(a) on Patent Application No(s). 102142038 filed in Taiwan, Republic of China on Nov. 19, 2013. This and all other extrinsic materials discussed herein are incorporated by reference in their entirety.

### BACKGROUND OF THE INVENTION

1. Field of Invention

The present invention relates to a liquid crystal display (LCD) panel and, in particular, to an LCD panel having multi-domains alignments.

2. Related Art

With the progress of technologies, display devices have been widely applied to various kinds of fields. Especially, liquid crystal display (LCD) devices, having advantages such as compact structure, low power consumption, less weight and less radiation, gradually take the place of cathode ray tube (CRT) display devices, and are widely applied to various electronic products, such as mobile phones, portable multimedia devices, notebooks, LCD TVs and LCD screens.

A conventional liquid crystal display (LCD) apparatus includes an LCD panel and a backlight module disposed opposite to the LCD panel. The LCD panel mainly includes a thin film transistor (TFT) substrate, a color filter (CF) substrate and a liquid crystal layer disposed between the two substrates. The CF substrate, the TFT substrate and the LC layer can form a plurality of pixel units disposed in a matrix. The backlight module emits the light passing through the LCD panel, and the pixel units of the LCD panel can display images accordingly.

In order to broaden the viewing angle of VA (Vertical Alignment) LCD panel, the manufacturers have introduced the photo-alignment technology for controlling the alignment direction of liquid crystal molecules so as to improve the optical performance and production yield of the LCD panels. The photo-alignment technology is to configure multi-domains of alignment diction in each pixel unit, so that the liquid crystal molecules in one pixel unit are tilted towards, for example, four different directions. In the photo-alignment technology, a UV light (e.g. a polarized light) is provided to illuminate a polymer film (alignment layer) disposed on the color filter (CF) substrate or thin-film transistor (TFT) substrate to induce non-uniform photo polymerization, isomerization or cracking reaction of the polymer structure at the surface of the polymer film. Accordingly, the chemical bonding structure of the film surface can generate a specific direction for controlling the tilting direction the liquid crystal molecules, thereby achieving the purpose of photo alignment.

However, if the CF substrate and the TFT substrate have shift and misalignment issues during the assembling process, the poor display quality of the LCD panel is deserved.

Therefore, it is an important subject to provide a liquid crystal display panel that can improve the shift and misalignment issues so as to ensure the good display quality thereof.

### SUMMARY OF THE INVENTION

In view of the foregoing subject, an objective of the present invention is to provide a liquid crystal display (LCD) panel that can improve the shift and misalignment issues so as to ensure the good display quality thereof.

To achieve the above objective, the present invention discloses a liquid crystal display (LCD) panel comprising a first substrate, a second substrate, a plurality of pixel units, a first alignment layer and a second alignment layer. The second substrate is disposed opposite to the first substrate. The pixel units are configured in a matrix formed by columns and rows, and each pixel unit is divided into a plurality of domains. The first alignment layer is disposed on the first substrate, and the second alignment layer is disposed on the second substrate. The domains of the pixel units have different tilt directions for liquid crystal molecules defined by the first alignment layer and the second alignment layer. In any adjacent two of the pixel units arranged in the row direction, the domains adjacent to a boundary between the two adjacent pixel units have the same tilt direction for liquid crystal molecules defined by the first alignment layer and the second alignment layer.

In one embodiment, the LCD panel further includes a first substrate and a second substrate disposed opposite to the first substrate. The first alignment layer is disposed on one of the first substrate and the second substrate, and the second alignment layer is disposed on the other one of the first substrate and the second substrate.

In one embodiment, the domains of each of the pixel units are in a matrix constructed by columns and rows, and the alignment directions of the domains at first and second columns in a second row are the same as the alignment directions of domains at first and second columns in a third row, respectively.

In one embodiment, in any adjacent two of the pixel units arranged in the column direction, the domains adjacent to a boundary between the two adjacent pixel units have the same tilt direction for liquid crystal molecules defined by the first alignment layer and the second alignment layer.

In one embodiment, the pixel units comprises a first pixel unit, a second pixel unit, a third pixel unit and a fourth pixel unit. The first pixel unit is disposed adjacent to the second pixel unit along the column direction, the first pixel unit is disposed adjacent to the third pixel unit along the row direction, and the third pixel unit is disposed adjacent to the fourth pixel unit along the column direction.

In one embodiment, the first alignment layer corresponding to the domains in the first columns of the first pixel unit and the second pixel unit has an alignment direction being a first direction of the column direction, and the first alignment layer corresponding to the domains in the second columns of the first pixel unit and the second pixel unit has an alignment being a second direction of the column direction.

In one embodiment, the alignment direction of the first alignment layer corresponding to the domains in the first columns of the third pixel unit and the fourth pixel unit is the second direction of the column direction, and the alignment direction of the first alignment layer corresponding to the domains in the second columns of the third pixel unit and the fourth pixel unit is the first direction of the column direction.

In one embodiment, the second alignment layer corresponding to the domains in the second and third rows of the first pixel unit and the third pixel unit has an alignment direction being one of a first direction and a second direction of the row direction, and the second alignment layer corresponding to the domains in the first and fourth rows of the first pixel unit and the third pixel unit has an alignment direction being the other one of the first direction and the second direction of the row direction.

In one embodiment, the second alignment layer corresponding to the domains in the second and third rows of the first pixel unit, the second pixel unit, the third pixel unit and the fourth pixel unit has an alignment direction being one of a first direction and a second direction of the row direction.

In one embodiment, the second alignment layer corresponding to the domains in the second and third rows of the first pixel unit and the third pixel unit and the alignment direction of the second alignment layer corresponding to the domains in the second and third rows of the second pixel unit and the fourth pixel unit have corresponding alignment directions respectively, which are opposite directions of the row direction.

In one embodiment, the LCD panel further includes a curved display panel.

To achieve the above objective, the present invention further includes a first substrate, a second substrate, a first alignment layer and a second alignment layer. The first substrate has a curved side along a row direction, and the second substrate is disposed opposite to the first substrate. The first alignment layer is disposed on one of the first substrate and the second substrate. The second alignment layer is disposed on the other one of the first substrate and the second substrate. The domains of the pixel units have different tilt directions for liquid crystal molecules defined by the first alignment layer and the second alignment layer. In any adjacent two of the pixel units arranged in the row direction, the domains adjacent to a boundary between the two adjacent pixel units have the same tilt direction for liquid crystal molecules defined by the first alignment layer and the second alignment layer.

In one embodiment, a curvature radius of the curved side is between 500 mm and 10000 mm.

In one embodiment, the curvature radius of the curved side is between 2000 mm and 6000 mm.

To achieve the above objective, the present invention further includes a first substrate, a second substrate, a first alignment layer and a second alignment layer. The first substrate has a curved side along a row direction, and the second substrate is disposed opposite to the first substrate. The first alignment layer is disposed on one of the first substrate and the second substrate, and has an alignment direction parallel to a column direction. The second alignment layer is disposed on the other one of the first substrate and the second substrate, and has an alignment direction parallel to the row direction.

As mentioned above, in the LCD panel of the invention, a plurality of pixel units are arranged in a matrix formed by columns and rows, and each pixel unit is divided into a plurality of domains. Besides, the alignment direction of the first alignment layer is parallel to the column direction, while the alignment direction of the second alignment layer is parallel to the row direction. The domains of the pixel units have different tilt directions for liquid crystal molecules defined by the first and second alignment layers. The domains adjacent to a boundary between the two adjacent pixel units arranged in the row direction have the same tilt direction for liquid crystal molecules defined by the first and second alignment layers. For the entire LCD panel, the unbalance of domain areas in the pixel units caused by shift or misalignment issue can be sufficiently solved due to the self-compensation of all pixel units. Consequently, the unsatisfied optical expression of side view caused by the unbalance domain areas can be improved, thereby providing the LCD panel with better display quality.

### BRIEF DESCRIPTION OF THE DRAWINGS

The invention will become more fully understood from the detailed description and accompanying drawings, which are given for illustration only, and thus are not limitative of the present invention, and wherein:

FIG. 1 is a side view of an LCD panel according to a preferred embodiment of the invention;

FIG. 2 is a top view of the LCD panel of FIG. 1;

FIGS. 3A to 3D are schematic diagrams showing the adjacent pixel units P1-P4 in the LCD panel applying the photo-alignment process;

FIG. 3E is a schematic diagram showing the domains of two adjacent pixel units in the row direction as the TFT substrate and the CF substrate are precisely aligned;

FIG. 3F is a schematic diagram showing the domains of two adjacent pixel units in the row direction while the TFT substrate and the CF substrate are misaligned;

FIGS. 4A-4D, 5A-5D and 6A-6D are schematic diagrams showing different aspects of the adjacent pixel units P1-P4 in the LCD panel applying the photo-alignment process;

FIGS. 7A to 7D are schematic diagrams showing another aspect of the adjacent pixel units P1-P4 in the LCD panel applying the photo-alignment process;

FIG. 7E is a schematic diagram showing the dark fringes of the pixel units in the LCD panel according to the embodiment of the invention;

FIGS. 8A to 8D are schematic diagrams showing the tilt directions for liquid crystal molecules in each domain of the pixel units P1 to P4 of another aspect and the corresponding dark fringes; and

FIGS. 9A and 9B are a perspective view and a top view of another aspect of the LCD panel according to the embodiment of the invention.

### DETAILED DESCRIPTION OF THE INVENTION

The present invention will be apparent from the following detailed description, which proceeds with reference to the accompanying drawings, wherein the same references relate to the same elements.

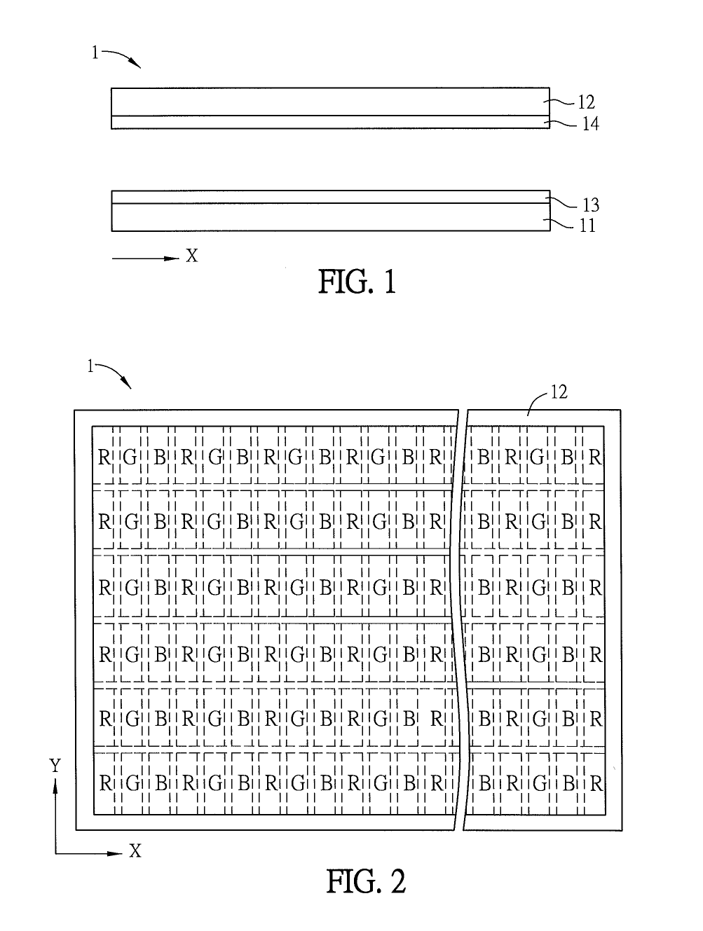

FIG. 1 is a side view of a liquid crystal display (LCD) panel 1 according to a preferred embodiment of the invention, and FIG. 2 is a top view of the LCD panel 1 of FIG. 1.

Referring to FIGS. 1 and 2, the LCD panel 1 includes a first substrate 11, a second substrate 12 and a liquid crystal layer (not shown) including a plurality of liquid crystal molecules. The liquid crystal layer is sandwiched between the first substrate 11 and the second substrate 12, and the first substrate 11, the second substrate 12 and the liquid crystal layer form a plurality of pixel units. The pixel units are configured in a matrix formed by columns and rows, and each pixel unit is divided into a plurality of domains (multi-domain). The domains in each pixel unit are similarly configured in a matrix formed by columns and rows. In this case, the first substrate 11 is a thin-film transistor (TFT) substrate, while the second substrate 12 is a color filter (CF) substrate. Otherwise, in other embodiments, the first substrate 11 can be a CF substrate, while the second substrate 12 is a TFT substrate. In this embodiment, the first substrate 11 is a TFT substrate formed with circuits for driving the pixel units, and the second substrate 12 is a CF substrate formed with a color filter layer (including red R, green G and blue B). Alternatively, the black matrix and color filter layer can be formed on the TFT substrate instead of the CF substrate so as to form a BOA (BM on array) substrate or a COA (color filter on array) substrate. This invention is not limited.

The LCD panel 1 further includes a first alignment layer 13 and a second alignment layer 14. The first alignment layer 13 has an alignment direction parallel to the column direction Y of the pixel unit matrix, and the second alignment layer 14 has an alignment direction parallel to the row direction X of the pixel unit matrix. As shown in FIG. 2, the column direction Y represents a vertical direction (top and bottom) in the top view of the LCD panel 1, and the row direction X represent a horizontal direction (left and right) in the top view of the LCD panel 1. The column direction Y and the row direction X are substantially perpendicular to each other. The column direction Y includes a first direction from the top to the bottom and a second direction from the bottom to the top. The row direction includes a first direction from left to right and a second direction from right to left. The detailed structure thereof will be described hereinafter.

The first alignment layer 13 can formed on either one of the first substrate 11 and the second substrate 12, while the second alignment layer 14 is formed on the other one thereof. In other words, if the first alignment layer 13 is formed on the first substrate 11, the second alignment layer 14 is formed on the second substrate 12. On the contrary, if the first alignment layer 13 is formed on the second substrate 12, the second alignment layer 14 is formed on the first substrate 11. In this embodiment, the first alignment layer 13 is formed on the first substrate 11 (TFT substrate), and the second alignment layer 14 is formed on the second substrate 12 (CF substrate). The material of the first alignment layer 13 and the second alignment layer 14 is, for example but not limited to, polyimide (PI).

By using the photo-alignment process in cooperating with the first alignment layer 13 and the second alignment layer 14, each pixel unit of the LCD panel 1 can be defined with different tilt directions for liquid crystal molecules. Herein, four different tilt directions for liquid crystal molecules are created. In more specific, under some critical exposing conditions, the alignment layer disposed on the TFT substrate can be aligned toward the first or second direction in the column direction Y, and the alignment layer disposed on the CF substrate can be aligned toward the first or second direction in the row direction X. The combination and cooperation of the alignment layers on the TFT and CF substrates can form the desired multiple domains with different tilt directions for liquid crystal molecules. The detailed description thereof will be illustrated below with reference the related figures.

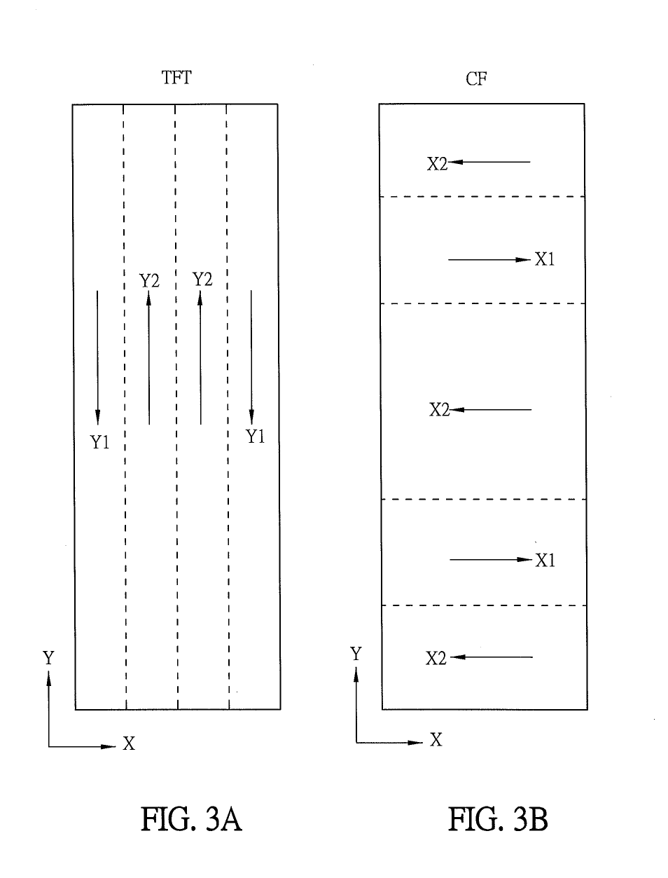

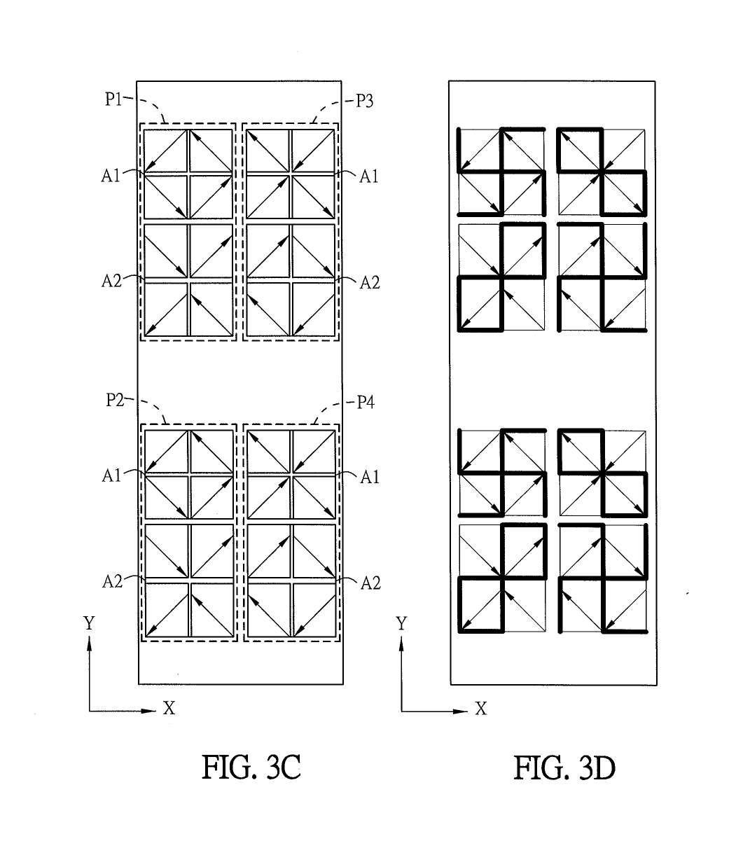

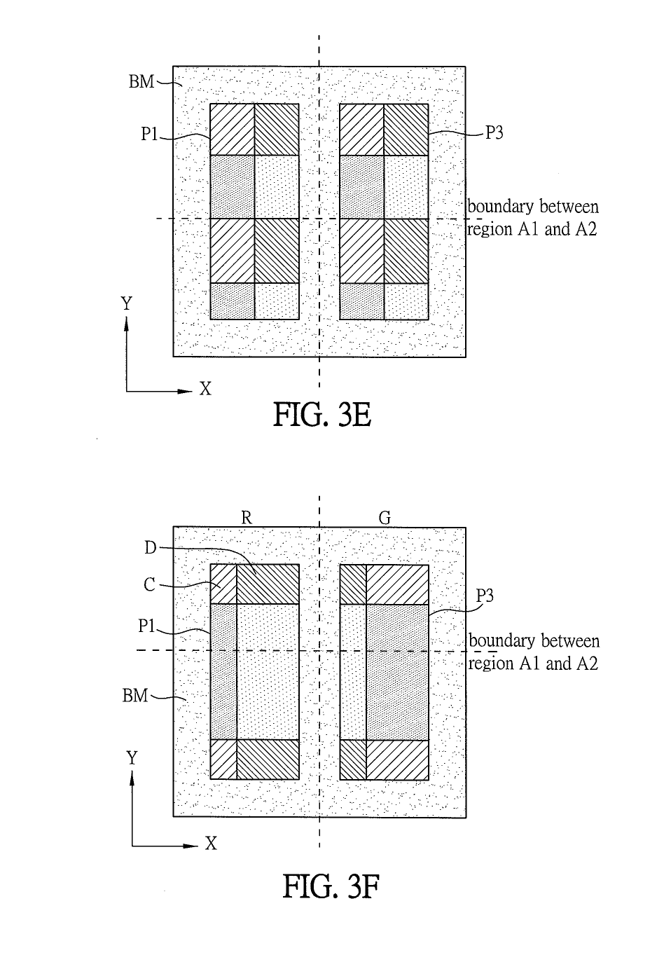

FIGS. 3A to 3D are schematic diagrams showing the adjacent pixel units P1-P4 in the LCD panel 1 applying the photo-alignment process. FIGS. 3A and 3B show the alignment directions of the alignment layers on the TFT and CF substrates, FIG. 3C shows the tilt direction for liquid crystal molecules in each domain within the pixel units P1-P4, and FIG. 3D shows the dark fringe generated in the pixel units P1-P4. Herein, the pixel units P1-P4 are considered as a group, and a plurality of groups of pixel units P1-P4 form the pixel unit matrix. In addition, the pixel unit P1 is disposed adjacent to the pixel unit P2 along the column direction Y, the pixel unit P3 is disposed adjacent to the pixel unit P4 along the column direction Y, the pixel unit P1 is disposed adjacent to the pixel unit P3 along the row direction X, and the pixel unit P2 is disposed adjacent to the pixel unit P4 along the row direction X.

Each pixel unit (e.g. pixel unit P1, P2, P3 or P4) represents a subpixel of the LCD panel 1. In this embodiment, as shown in FIG. 3C, the pixel units P1-P4 are divided into eight domains, which are arranged in four rows and two columns. In other words, the pixel units P1-P4 are arranged from a first row to a fourth row from top to bottom; otherwise, they are arranged from a first column to a second column from left to right. Of course, in other embodiments, the pixel units P1-P4 can be divided into four domains, which are arranged in two rows and two columns, or the likes. Alternatively, the pixel units P1-P4 can be divided into sixteen domains, which are arranged in eight rows and two columns, or the likes. The numbers of the domains within each pixel unit is not limited in this invention.

Referring to FIG. 3C again, the domains of the first and second rows in each pixel unit are arranged in a first region A1, while the domains of the third and fourth rows in each pixel unit are arranged in a second region A2. The first region A1 and the second region A2 are electrically connected to the same scan line, but receive image data from different data lines. Since each pixel unit is divided into two regions, so it is possible to obtain a front-view gamma curve or similar by combining the gamma curves of two regions in an off-axis side view. Accordingly, the LCD panel 1 can have better display quality.

The arrow direction in either FIG. 3A or 3B indicates the alignment direction of the alignment layer on the TFT or CF substrate, and the arrow direction in each domain of FIG. 3C indicates the tilt direction of liquid crystal molecules (long axis), which is also the combination force direction of the alignment layers of TFT and CF substrates. For example, if the alignment direction of the alignment layer on the TFT substrate is the first direction Y1 (from top to bottom) of the column direction Y, and the alignment direction of the alignment layer on the CF substrate is the second direction X2 (from right to left) of the row direction X, the liquid crystal molecules tilt toward left bottom, such as the arrow direction in the domains at first column of first row inside the pixel unit P1.

With reference to FIGS. 3A and 3C, the alignment direction of the alignment layer on the TFT substrate corresponding to the domains in the first columns of the first pixel unit P1 and the second pixel unit P2 is the first direction Y1 of the column direction Y, and the alignment direction of the alignment layer corresponding to the domains in the second columns of the first pixel unit P1 and the second pixel unit P2 is the second direction Y2 of the column direction Y. In addition, the alignment direction of the alignment layer corresponding to the domains in the first columns of the third pixel unit P3 and the fourth pixel unit P4 is the second direction Y2 of the column direction Y, and the alignment direction of the first alignment layer corresponding to the domains in the second columns of the third pixel unit P3 and the fourth pixel unit P4 is the first direction Y1 of the column direction Y.

With reference to FIGS. 3B and 3C, the alignment direction of the alignment layer on the CF substrate corresponding to the domains in the second and third rows of the first pixel unit P1 and the third pixel unit P3 is the first direction X1 of the row direction X, and the alignment direction of the alignment layer corresponding to the domains in the first and fourth rows of the first pixel unit P1 and the third pixel unit P3 is the second direction X2 of the row direction X. Similarly, the alignment direction of the alignment layer on the CF substrate corresponding to the domains in the second and third rows of the second pixel unit P2 and the fourth pixel unit P4 is the first direction X1 of the row direction X, and the alignment direction of the alignment layer corresponding to the domains in the first and fourth rows of the second pixel unit P2 and the fourth pixel unit P4 is the second direction X2 of the row direction X. In this case, the alignment direction of the alignment layer on the CF substrate corresponding to the domains in the second and third rows of the first pixel unit P1 and the third pixel unit P3 and the alignment direction of the alignment layer corresponding to the domains in the second and third rows of the second pixel unit P2 and the fourth pixel unit P4 are both the first direction X1 of the row direction X.

Referring to FIGS. 3C and 3D, the domains in the first region A1 or the second region A2 of each pixel unit have four different tilt directions for liquid crystal molecules defined by the alignment layers on the TFT and CF substrates. Under the linear polarizer along with different tilt directions, two different types of dark fringes including a [symbol] shape and an 8 shape (tilt 8) are observed. Regarding to the pixel unit P1, the tilt directions of four domains in the first region A1 are arranged in a counterclockwise direction, so that the corresponding dark fringes show a reversed [symbol] shape (see FIG. 3D), and the dark fringes corresponding to the tilt directions of four domains in the second region A2 show a 8 shape tilting rightwards (see FIG. 3D). Regarding to the pixel unit P3, the dark fringes corresponding to the tilt directions of four domains in the first region A1 show an 8 shape tilting leftwards, and the tilt directions of four domains in the second region A2 are arranged in a clockwise direction, so that the corresponding dark fringes show a [symbol] shape. As a result, the tilt directions for liquid crystal molecules of each domain in the pixel unit as shown in FIG. 3C can be obtained based on the alignment directions of the alignment layers on the TFT and CF substrates as shown in FIGS. 3A and 3B, thereby providing the desired dark fringe structure as shown in FIG. 3D. Herein, FIG. 3D shows a double [symbol] 8 design.

In any adjacent two pixel units arranged in the row direction X, the domains adjacent to the boundary between the two adjacent pixel units have the same tilt direction for liquid crystal molecules defined by the alignment layers on the TFT and CF substrates. As shown in FIG. 3C, regarding to adjacent pixel units P1 and P3, the tilt direction for liquid crystal molecules of the second column in the pixel unit P1 is the same as that of the first column in the pixel unit P3. Similarly, the tilt direction for liquid crystal molecules of the second column in the pixel unit P2 is the same as that of the first column in the adjacent pixel unit P4.

FIG. 3E is a schematic diagram showing the domains of two adjacent pixel units (e.g. pixel units P1 and P3) in the row direction X as the TFT substrate and the CF substrate are precisely aligned, and FIG. 3F is a schematic diagram showing the domains of two adjacent pixel units (e.g. pixel units P1 and P3) in the row direction X while the TFT substrate and the CF substrate are misaligned. The misalignment of the TFT substrate and the CF substrate may be caused by the improper or uncritical alignment and assembling processes; otherwise, this misalignment may also be existed as the LCD panel 1 is a curved display panel. If the LCD panel 1 is a curved display panel, the first substrate 11 (and the second substrate 12) of the LCD panel 1 has a curved side along a row direction X, and the curved side has a curvature radius ranged between 500 mm and 10000 mm. Preferably, the curvature radius ranges between 2000 mm and 6000 mm. Since the alignment direction of the second alignment layer 14 is parallel to the row direction X of the pixel unit matrix, the curve of the LCD panel 1 along the row direction X is parallel to the alignment direction (row direction X) of the second alignment layer 14. In this embodiment, the second alignment layer 14 of the LCD panel 1 is formed on the second substrate 12 (CF substrate). That is, the alignment direction of the alignment layer on the CF substrate and the LCD panel 1 have the same curved direction.

Referring to FIG. 3E, when the two substrate are not misaligned, the areas of the domains in the pixel units P1 and P3 are balanced. However, as shown in FIG. 3F, when the TFT and CF substrates are misaligned, the horizontal shift (row direction X) of the pixel units P1 and P3 makes the black matrix BM generate shift so that the areas of the domains in the pixel units become unbalance (domain C becomes smaller while domain D becomes larger). Since the colors of the pixel units are RGB cycles along the row direction X, the domains C of red color R in the first column becomes smaller and the domains D of red color R in the first column becomes larger, the domains C of red color R in the fourth column becomes larger and the domains D of red color R in the fourth column becomes smaller, the domains C of red color R in the seventh column becomes smaller and the domains D of red color R in the seventh column becomes larger, and so on. The domains of green color G and blue color B all have the same cycles. Regarding to the entire LCD panel 1, the unbalance areas of the domains in individual pixel unit can have self compensation as considering the whole pixel units, so that all domains can be balanced. Accordingly, the unsatisfied optical expression of side view caused by the unbalance domain areas due to the undesired misalignment can be improved, thereby providing the LCD panel 1 with better display quality.

With reference to FIG. 3C, in any adjacent two pixel units arranged in the column direction Y, the domains adjacent to the boundary between the two adjacent pixel units have the same tilt direction for liquid crystal molecules defined by the alignment layers on the TFT and CF substrates. In more specific, the first and second columns of the pixel units P1 and P2 have the same tilt direction for liquid crystal molecules.

Besides, in each pixel unit, the alignment directions of the domains at first and second columns in a second row are the same as the alignment directions of domains at first and second columns in a third row, respectively. Moreover, in each pixel unit P1, P2, P3 or P4, the alignment directions of the domains at first and second columns in the second row are the same as the alignment directions of domains at first and second columns in the third row, respectively. Since the alignment directions of the domains at first and second columns in the second row of the alignment layer on the CF substrate are the same as the alignment directions of domains at first and second columns in a third row of the alignment layer on the CF substrate, respectively, the boundary of the first region A1 and the second region A2 in each pixel unit has the same tilt direction for liquid crystal molecules. As a result, if the TFT and CF substrates are misaligned, the vertical direction (column direction Y) portion of the shifted black matrix will not generate discontinuous boundary line of the alignment direction around the boundary of the first region A1 and the second region A2. Accordingly, no additional dark fringe is generated between the first region A1 and the second region A2 of each pixel unit, so that the transmittance of the LCD panel 1 is not decreased and the display quality thereof is secured.

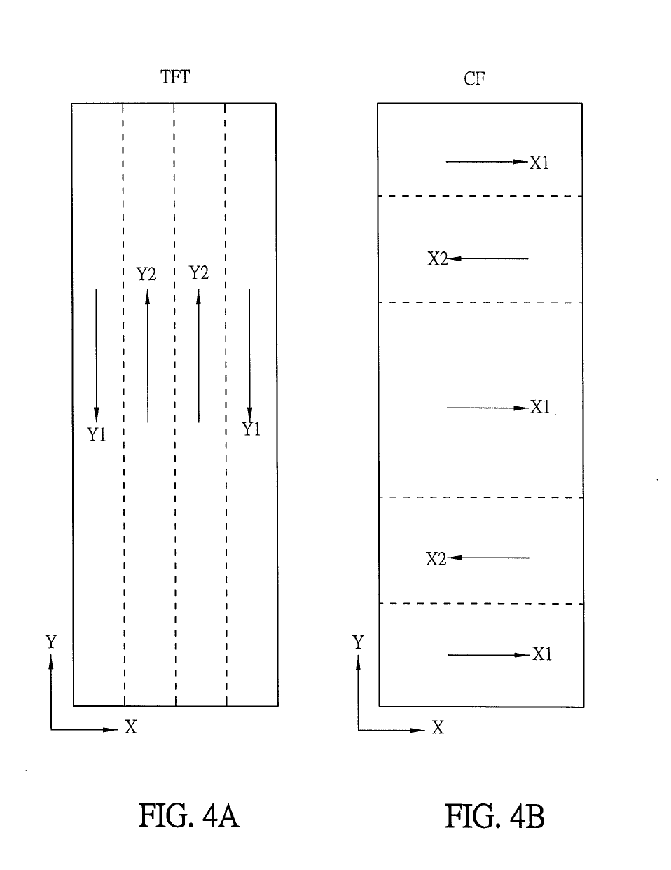

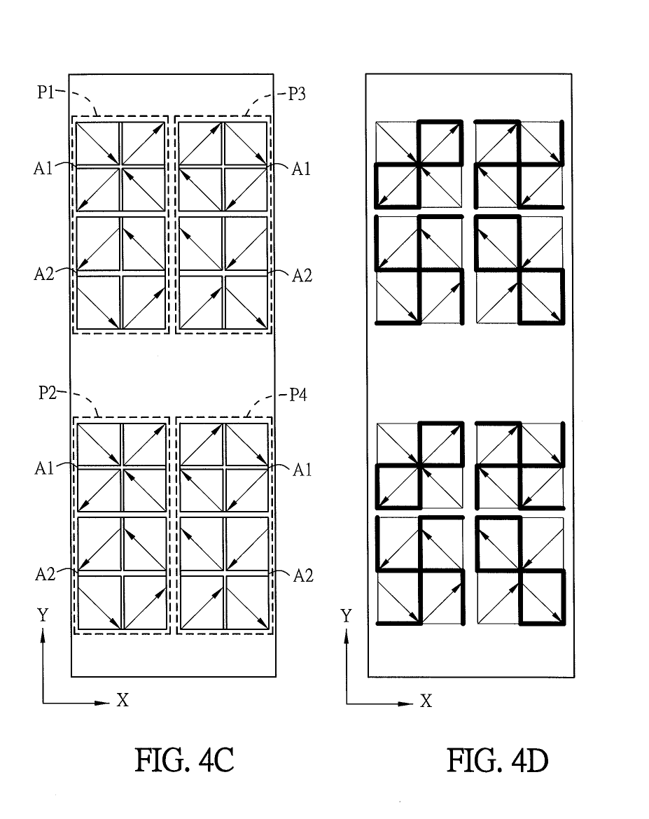

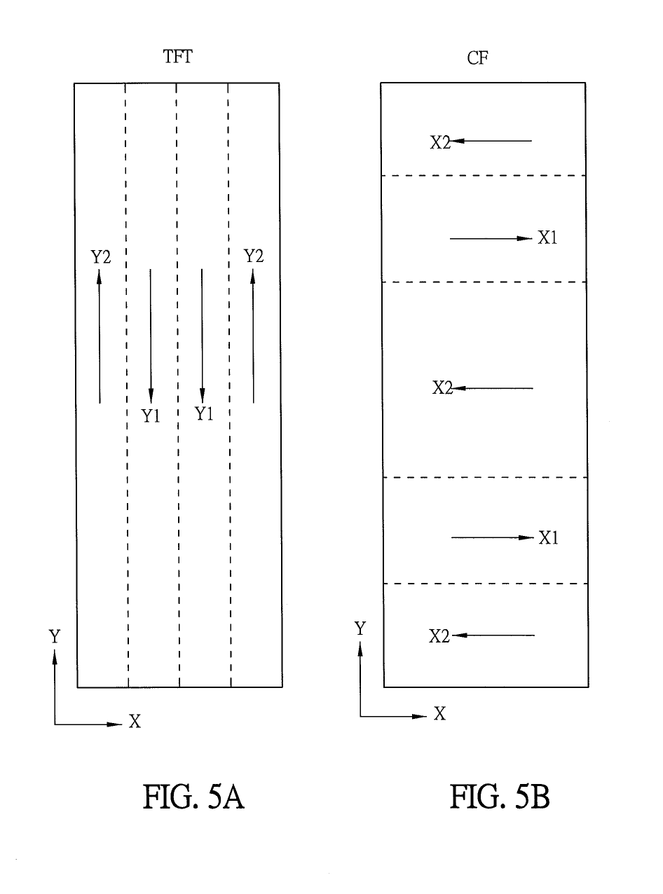

Please referring to FIGS. 4A to 6D, which are schematic diagrams showing different aspects of the adjacent pixel units P1-P4 in the LCD panel 1 applying the photo-alignment process.

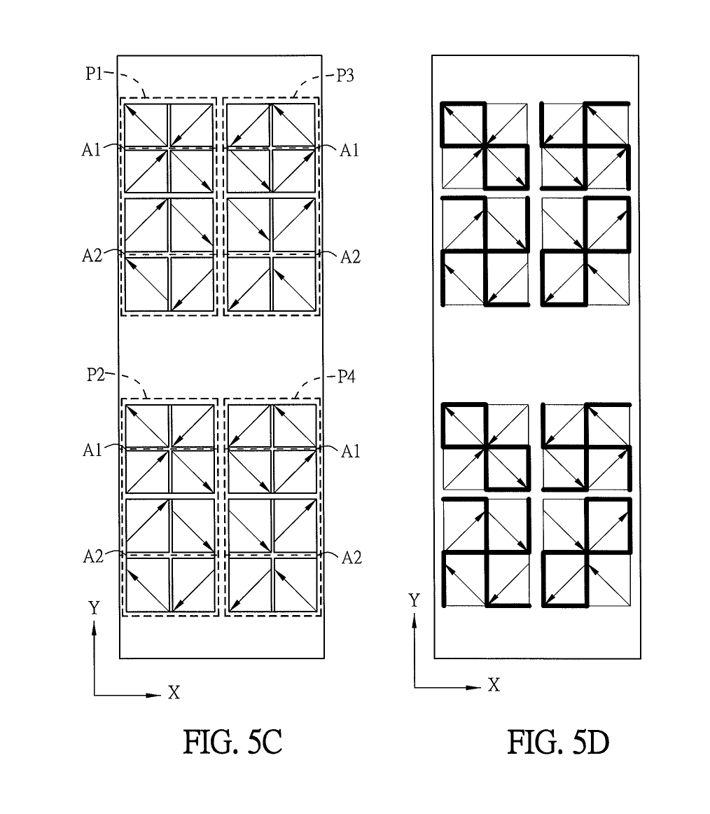

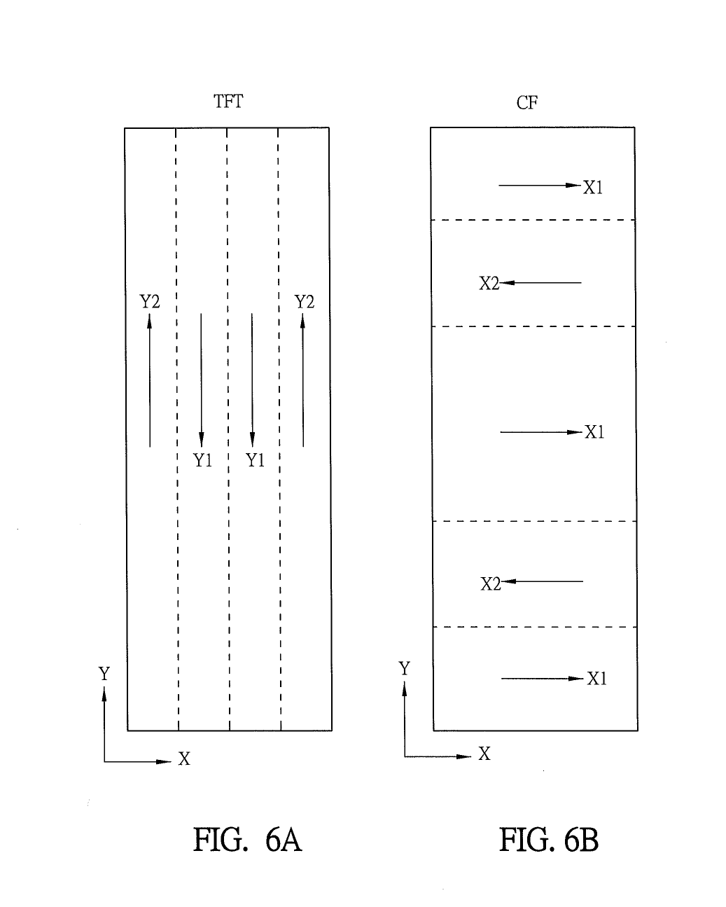

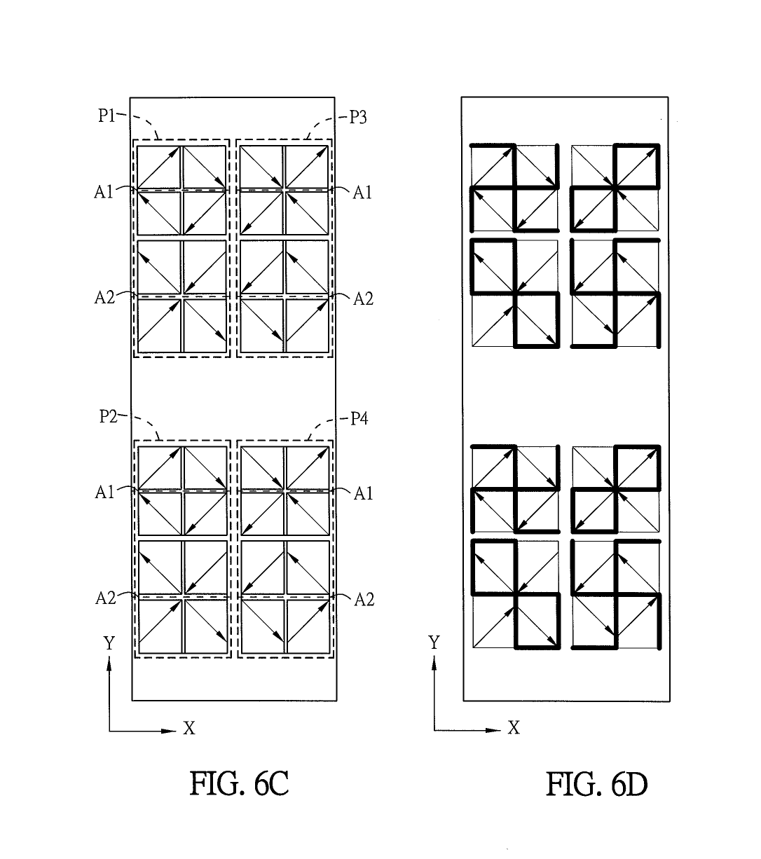

As shown in FIGS. 4A and 4B, the alignment directions in the regions of the alignment layer on the CF substrate as shown in FIG. 4 B is opposite to those shown in FIG. 3B (the alignment directions of the alignment layers on the TFT substrate shown in FIGS. 4A and 3A are the same). Referring to FIGS. 5A and 5B, the alignment directions in the regions of the alignment layer on the TFT substrate as shown in FIG. 5A is opposite to those shown in FIG. 3A (the alignment directions of the alignment layers on the CF substrate shown in FIGS. 5B and 3B are the same). Referring to FIGS. 6A and 6B, the alignment directions in the regions of the alignment layer on the CF substrate as shown in FIG. 6B is opposite to those shown in FIG. 5B (the alignment directions of the alignment layers on the TFT substrate shown in FIGS. 6A and 3A are the same). As a result, the tilt direction for liquid crystal molecules and corresponding dark fringes in each domain of pixel units P1-P4 can form the patterns as shown in FIGS. 4C and 4D, FIGS. 5C and 5D, and FIGS. 6C and 6D.

Besides, in the aspects of FIGS. 4A-4D, FIGS. 5A-5D and FIGS. 6A-6D, the unbalance areas of the domains in individual pixel unit can have self compensation as considering the whole pixel units, so that all domains can be balanced. Accordingly, the alignment configurations of the aspects of FIGS. 4A-4D, FIGS. 5A-5D and FIGS. 6A-6D can also solve the unbalance issue of domain areas caused by shift and/or misalignment of two substrates, thereby providing the LCD panel 1 with better display quality. The detailed descriptions thereof can be referred to those discussed in the previous embodiment in FIG. 3A-3D, so the detailed descriptions thereof will be omitted.

With reference to FIG. 3D, since the generated dark fringes shown in FIG. 3D form a double [symbol] 8 shape, if the panel proceeds a low gray-level display and the second region A2 of all pixel units in the LCD panel 1 are turned off while the first region A1 thereof are turned on, each pixel unit in the nth column (e.g. pixel unit P1 or P2) shows [symbol] and each pixel unit in the (n+1)th column (e.g. pixel unit P3 or P4) shows 8. Since the dark fringes shown in the nth column all form [symbol] and the dark fringes shown in the (n+1)th column all form 8, regarding to the red color R (the row direction configures RGB, RGB, RGB and so on), the red color R of the first column shows [symbol] , the red color R of the fourth column shows 8, the red color R of the seventh column shows [symbol] , and so on. Unfortunately, the viewer may receive undesired bright and dark line image problem along the vertical direction (column direction Y) due to the unbalanced red color brightness. This problem also exists in the green color G and blue color B.

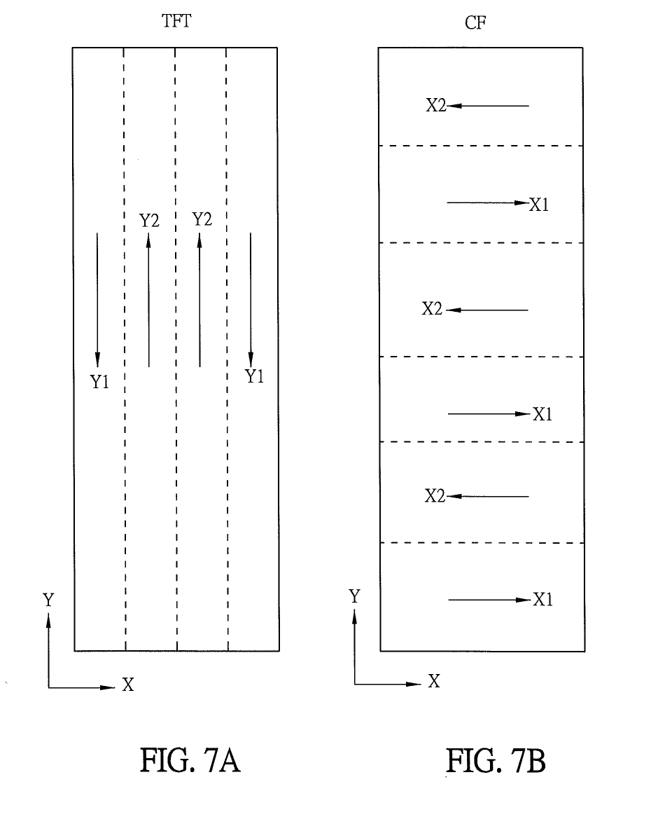

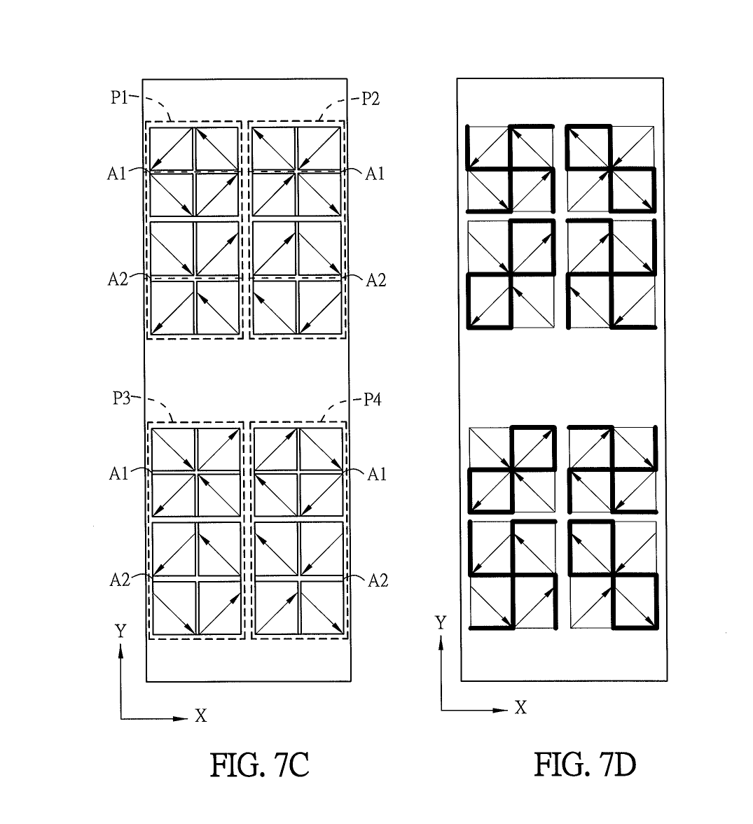

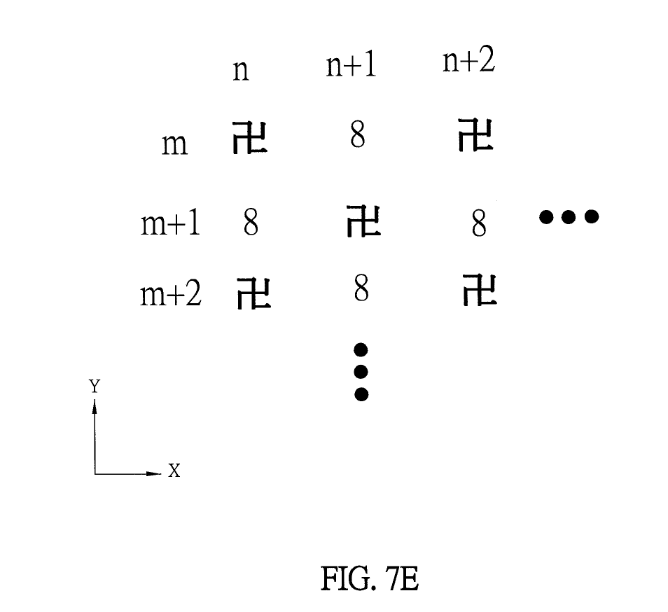

In order to improve the bright and dark line image problem along the vertical direction, the LCD panel 1 of another aspect is disclosed with reference to FIGS. 7A to 7D, which are schematic diagrams showing another aspect of the adjacent pixel units P1-P4 in the LCD panel applying the photo-alignment process.

The alignment direction of the alignment layer on the TFT substrate shown in FIG. 7A is the same as that shown in FIG. 3A, but the alignment direction of each region of the alignment layer on the CF substrate shown in FIG. 7B is different from that shown in FIG. 3B. In this case, the alignment directions of the domains on the CF substrate along the column direction Y shown in FIG. 3B are X2, X1, X1, X2, X2, X1, X1, X2, and so on (repeating X2, X1, X1, X2), while the alignment directions of the domains on the CF substrate along the column direction Y shown in FIG. 7B are X2, X1, X1, X2, X1, X2, X2, X1, and so on. Accordingly, the dark fringes corresponding to the tilt direction for liquid crystal molecules in the domains of pixel units P1-P4 can form the patterns shown in FIGS. 7C and 7D. The details of this aspect can be referred to those disclosed in the previous embodiments, so the descriptions thereof will be omitted. Herein, FIG. 7D shows an alternate double [symbol] 8 design.

In any adjacent two pixel units arranged in the column direction Y (e.g. pixel units P1 and P2, or P3 and P4) shown in FIG. 7C, the domains adjacent to the boundary between the two adjacent pixel units have different tilt directions for liquid crystal molecules defined by the alignment layers on the TFT and CF substrates (the fourth row of the pixel unit P1 is different from the first row of the pixel unit P2). Besides, the alignment direction (first direction X1) of the alignment layer on the CF substrate corresponding to the domains in the second and third rows of the first pixel unit P1 and the third pixel unit P3 and the alignment direction (second direction X2) of the alignment layer on the CF substrate corresponding to the domains in the second and third rows of the second pixel unit P2 and the fourth pixel unit P4 are opposite directions of the row direction X.

Therefore, when the panel proceeds a low gray-level display and the second region A2 of all pixel units in the LCD panel 1 are turned off while the first region A1 thereof are turned on shown in FIG. 7E, the dark fringes in the first region A1 of the pixel unit at the nth column and the mth row shows [symbol] , the dark fringes in the first region A1 of the pixel unit at the nth column and the (m+1)th row shows 8, the dark fringes in the first region A1 of the pixel unit at the nth column and the (m+2)th row shows [symbol] , and so on. Besides, the dark fringes in the first region A1 of the pixel unit at the (n+1)th column and the mth row shows 8, the dark fringes in the first region A1 of the pixel unit at the (n+1)th column and the (m+1)th row shows [symbol] , and so on. Accordingly, the pixel units of every column show the alternate [symbol] 8 [symbol] 8 [symbol] 8 . . . , so that the undesired bright and dark line image problem along the vertical direction caused by the unbalanced brightness in columns will not bother the viewers.

To be noted, in FIGS. 7A to 7D, the designer can follow the modifications as shown in FIGS. 4A to 6D to change the alignment configurations on the TFT substrate (see FIG. 7A) and the CF substrate (see FIG. 7B) so as to obtain additional three different combinations, thereby obtaining different tilt directions for liquid crystal molecules and corresponding dark fringes in domains of the pixel units. The detailed description thereof will be omitted here.

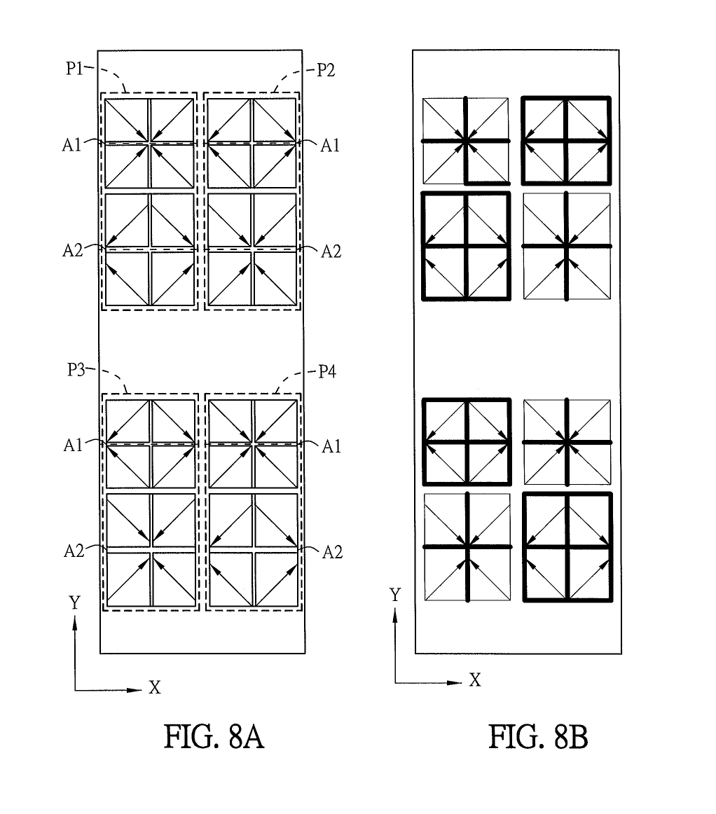

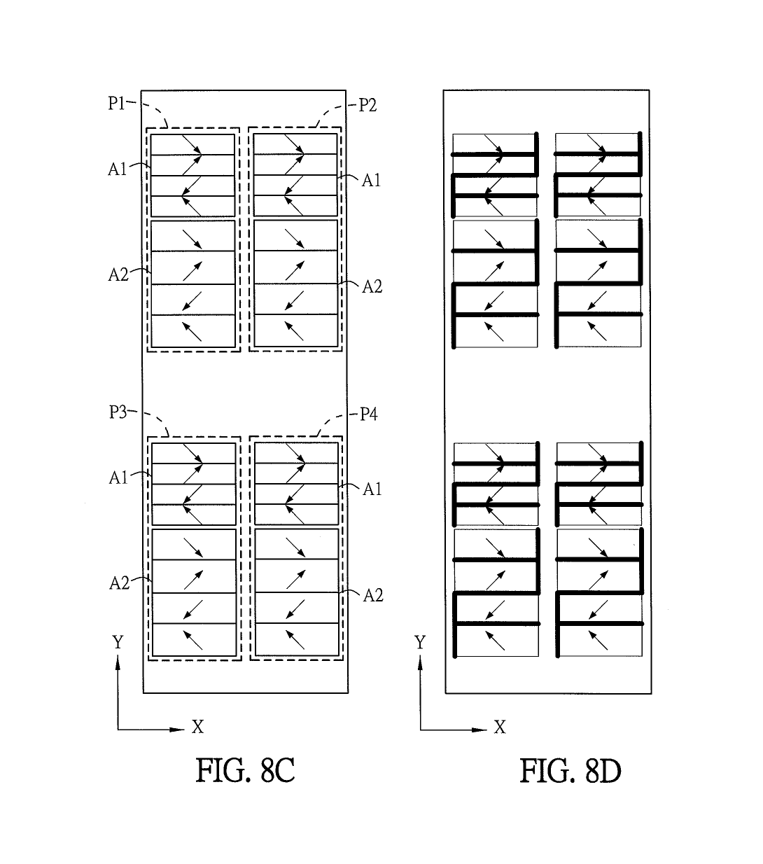

In other embodiments, it is also possible to obtain different dark fringes by disposing other alignment configurations. For example, FIGS. 8A and 8C are schematic diagrams showing the tilt directions for liquid crystal molecules in each domain of the pixel units P1 to P4 of another aspect, FIG. 8B is a schematic diagram showing the corresponding dark fringes of the pixel units P1 to P4 of FIG. 8A, and FIG. 8D is a schematic diagram showing the corresponding dark fringes of the pixel units P1 to P4 of FIG. 8C.

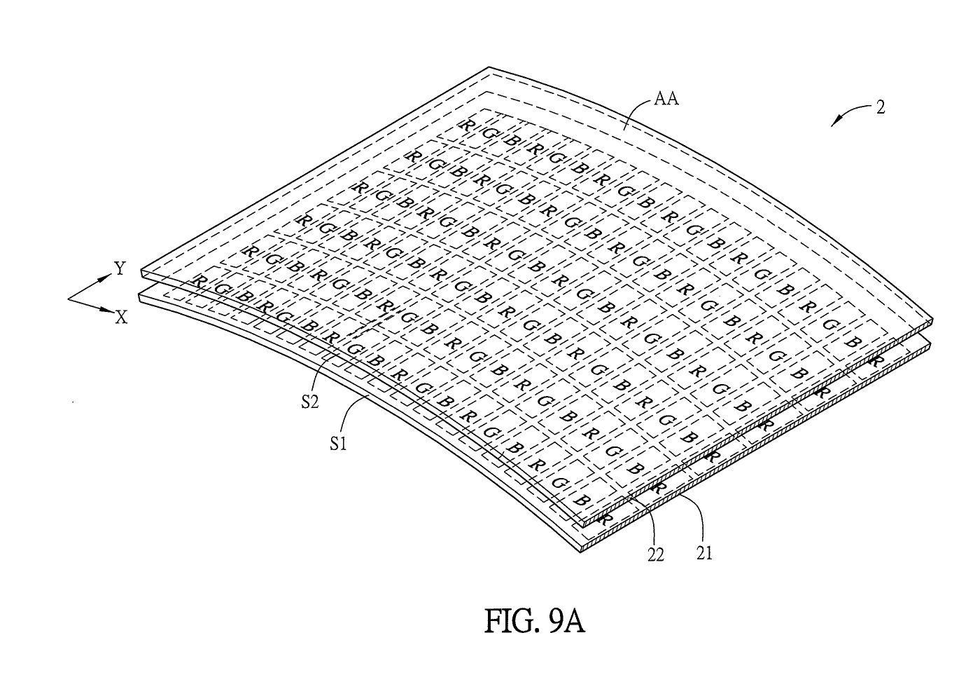

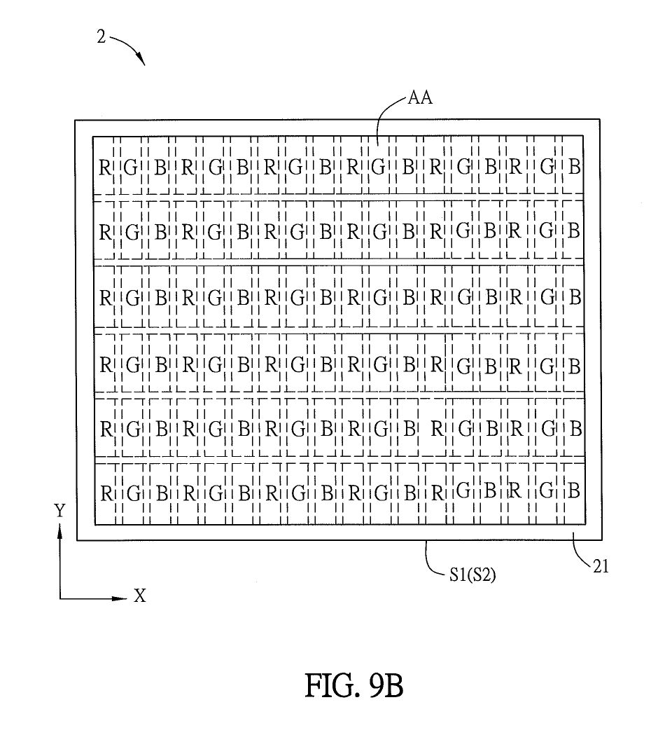

FIGS. 9A and 9B are a perspective view and a top view of an LCD panel 2 according to the embodiment of the invention.

The LCD panel 2 of this embodiment is a curved display panel and includes a first substrate 21 and a second substrate 22 disposed opposite to each other. In this case, the first substrate 21 is a TFT substrate formed with circuits for driving the pixel units, and the second substrate 22 is a CF substrate formed with a color filter layer. Of course, in other embodiments, the first substrate 21 is a CF substrate, while the second substrate 22 is a TFT substrate.

The curved LCD panel 2 includes a curved display screen AA, which is substantially an arc surface. In other words, viewing from the left or right side of the LCD panel 2, two sides of the LCD panel 2 are obviously curvier or protruding than the center portion thereof. Herein, two sides of the LCD panel 2 are curvier downwardly than the center portion thereof. Although the LCD panel 2 is a curved display panel, it looks like a rectangle from the top view thereof (see FIG. 9B). Moreover, the LCD panel 2 further includes a liquid crystal layer (not shown), which is sandwiched between the first substrate 21 and the second substrate 22, and includes a plurality of liquid crystal molecules (not shown). The first substrate 21 and the second substrate 22 along with the liquid crystal layer form a plurality of pixel units, which are configured in a matrix formed by columns and rows. Each pixel unit is divided into a plurality of domains, and the domains of each pixel unit are in a matrix constructed by columns and rows.

The first substrate 21 has a curved first side S1 along the row direction X, and the second substrate 22 has a curved second side S2 correspondingly. As viewing from an angle perpendicular to the first side S1 (or the second side S2) of the first substrate 21, the curved first side S1 or the curved second side S2 has a curvature radius. In this embodiment, this curvature radius is limited from 500 mm to 10000 mm, and preferably, from 2000 mm to 6000 mm.

In addition, the LCD panel 2 further includes a first alignment layer and a second alignment layer (not shown). The first alignment layer is form on one of the first substrate 21 and the second substrate 22, and the alignment direction of the first alignment layer is parallel to the column direction Y. The second alignment layer is form on the other one of the first substrate 21 and the second substrate 22, and the alignment direction of the second alignment layer is parallel to the row direction X of the pixel unit matrix. In other words, if the first alignment layer is formed on the first substrate 21, the second alignment layer is formed on the second substrate 22. On the contrary, if the first alignment layer is formed on the second substrate 22, the second alignment layer is formed on the first substrate 21. In this embodiment, the first alignment layer is formed on the first substrate 21 (TFT substrate), while the second alignment layer is formed on the second substrate 22 (CF substrate).

Since the alignment layer of the second alignment layer is parallel to the row direction X of the pixel unit matrix, the curve of the LCD panel 2 along the row direction X is parallel to the alignment direction (row direction X) of the second alignment layer. In this embodiment, the second alignment layer of the LCD panel 2 is formed on the second substrate 22 (CF substrate), so it is defined that the alignment direction of the alignment layer on the CF substrate and the LCD panel 2 have the same curved direction.

The LCD panel 2 is a curved display panel, so the CF substrate and the TFT substrate may be easy misaligned, thereby causing the unbalance areas of the domains in the pixel unit and thus decreasing the display quality. Similarly to the above-mentioned LCD panel 1, it is also possible to configure the alignment layer of the TFT substrate toward the first or second direction of the column direction Y, and configure the alignment layer of the CF substrate toward the first or second direction of the row direction X through the photo-alignment process under specific exposing conditions. By using the combination and cooperation of the two alignment layers to form the desired multiple domains with different tilt directions for liquid crystal molecules, the self compensation of all pixel units can be obtained so as to provide a proper balance for the entire domains of the display panel. Accordingly, the unsatisfied optical expression of side view caused by the unbalance domain areas due to the undesired misalignment can be improved, thereby providing the LCD panel 2 with better display quality.

Moreover, other technical features of the LCD panel 2 and other photo-alignment processes applied to the LCD panel 2 can be referred to the previous embodiments and aspects, so the detailed descriptions thereof will be omitted.

To sum up, in the LCD panel of the invention, a plurality of pixel units are arranged in a matrix formed by columns and rows, and each pixel unit is divided into a plurality of domains. Besides, the alignment direction of the first alignment layer is parallel to the column direction, while the alignment direction of the second alignment layer is parallel to the row direction. The domains of the pixel units have different tilt directions for liquid crystal molecules defined by the first and second alignment layers. The domains adjacent to a boundary between the two adjacent pixel units arranged in the row direction have the same tilt direction for liquid crystal molecules defined by the first and second alignment layers. For the entire LCD panel, the unbalance of domain areas in the pixel units caused by shift or misalignment issue can be sufficiently solved due to the self-compensation of all pixel units. Consequently, the unsatisfied optical expression of side view caused by the unbalance domain areas can be improved, thereby providing the LCD panel with better display quality.

Although the invention has been described with reference to specific embodiments, this description is not meant to be construed in a limiting sense. Various modifications of the disclosed embodiments, as well as alternative embodiments, will be apparent to persons skilled in the art. It is, therefore, contemplated that the appended claims will cover all modifications that fall within the true scope of the invention.

What is claimed is:

1. A liquid crystal display (LCD) panel, comprising:
a first substrate;
a second substrate disposed opposite to the first substrate;
a plurality of pixel units configured in a matrix formed by columns and rows, wherein each of the pixel units is divided into a plurality of domains;
a first alignment layer disposed on the first substrate; and
a second alignment layer disposed on the second substrate;
wherein, the domains of the pixel units have different tilt directions for liquid crystal molecules defined by the first alignment layer and the second alignment layer, and in any adjacent two of the pixel units arranged in the row direction, the domains adjacent to a boundary between the two adjacent pixel units have the same tilt direction for liquid crystal molecules defined by the first alignment layer and the second alignment layer.

2. The LCD panel of claim 1, wherein the domains of each of the pixel units are in a matrix constructed by columns and rows, and the alignment directions of the domains at first and second columns in a second row are the same as the alignment directions of domains at first and second columns in a third row, respectively.

3. The LCD panel of claim 1, wherein in any adjacent two of the pixel units arranged in the column direction, the domains adjacent to a boundary between the two adjacent pixel units have the same tilt direction for liquid crystal molecules defined by the first alignment layer and the second alignment layer.

4. The LCD panel of claim 1, wherein the pixel units comprises a first pixel unit, a second pixel unit, a third pixel unit and a fourth pixel unit, the first pixel unit is disposed adjacent to the second pixel unit along the column direction, the first pixel unit is disposed adjacent to the third pixel unit along the row direction, and the third pixel unit is disposed adjacent to the fourth pixel unit along the column direction.

5. The LCD panel of claim 4, wherein the first alignment layer corresponding to the domains in the first columns of the first pixel unit and the second pixel unit has an alignment direction being a first direction of the column direction, and the first alignment layer corresponding to the domains in the second columns of the first pixel unit and the second pixel unit has an alignment direction being a second direction of the column direction.

6. The LCD panel of claim 5, wherein the alignment direction of the first alignment layer corresponding to the domains in the first columns of the third pixel unit and the fourth pixel unit is the second direction of the column direction, and the alignment direction of the first alignment layer corresponding to the domains in the second columns of the third pixel unit and the fourth pixel unit is the first direction of the column direction.

7. The LCD panel of claim 4, wherein the second alignment layer corresponding to the domains in the second and third rows of the first pixel unit and the third pixel unit has an alignment direction being one of a first direction and a second direction of the row direction, and the second alignment layer corresponding to the domains in the first and fourth rows of the first pixel unit and the third pixel unit has an alignment direction being the other one of the first direction and the second direction of the row direction.

8. The LCD panel of claim 4, wherein the second alignment layer corresponding to the domains in the second and third rows of the first pixel unit, the second pixel unit, the third pixel unit and the fourth pixel unit has an alignment direction being one of a first direction and a second direction of the row direction.

9. The LCD panel of claim 4, wherein the second alignment layer corresponding to the domains in the second and third rows of the first pixel unit and the third pixel unit and the second alignment layer corresponding to the domains in the second and third rows of the second pixel unit and the fourth pixel unit have corresponding alignment directions respectively, which are opposite directions of the row direction.

10. The LCD panel of claim 1, further comprising a curved display panel.

11. A liquid crystal display (LCD) panel, comprising:
a first substrate having a curved side along a row direction;
a second substrate disposed opposite to the first substrate;
a first alignment layer disposed on one of the first substrate and the second substrate; and
a second alignment layer disposed on the other one of the first substrate and the second substrate,
wherein, the domains of the pixel units have different tilt directions for liquid crystal molecules defined by the first alignment layer and the second alignment layer, and in any adjacent two of the pixel units arranged in the row direction, the domains adjacent to a boundary between the two adjacent pixel units have the same tilt direction for liquid crystal molecules defined by the first alignment layer and the second alignment layer.

12. The LCD panel of claim 11, wherein a curvature radius of the side is between 500 mm and 10000 mm.

13. The LCD panel of claim 12, wherein the curvature radius of the side is between 2000 mm and 6000 mm.

14. The LCD panel of claim 11, further comprising:
a plurality of pixel units configured in a matrix formed by columns and rows, wherein each of the pixel units is divided into a plurality of domains,
wherein the domains of first and second rows of each of the pixel units or the domains of third and fourth rows of each of the pixel units have different tilt directions for liquid crystal molecules defined by the first alignment layer and the second alignment layer, and the domains of each of the pixel units are in a matrix constructed by columns and rows.

15. The LCD panel of claim 14, wherein in any adjacent two of the pixel units arranged in the row direction, the domains adjacent to a boundary between the two adjacent pixel units have the same tilt direction for liquid crystal molecules defined by the first alignment layer and the second alignment layer.

16. The LCD panel of claim 14, wherein the alignment directions of the domains at first and second columns in a second row are the same as the alignment directions of domains at first and second columns in a third row, respectively.

17. The LCD panel of claim 14, wherein in any adjacent two of the pixel units arranged in the column direction, the domains adjacent to a boundary between the two adjacent pixel units have the same tilt direction for liquid crystal molecules defined by the first alignment layer and the second alignment layer.

18. The LCD panel of claim 14, wherein the pixel units comprises a first pixel unit, a second pixel unit, a third pixel unit and a fourth pixel unit, the first pixel unit is disposed adjacent to the second pixel unit along the column direction, the first pixel unit is disposed adjacent to the third pixel unit along the row direction, and the third pixel unit is disposed adjacent to the fourth pixel unit along the column direction.

19. A liquid crystal display (LCD) panel, comprising:
a first substrate having a curved side along a row direction;
a second substrate disposed opposite to the first substrate;
a first alignment layer disposed on one of the first substrate and the second substrate, and having an alignment direction parallel to a column direction; and
a second alignment layer disposed on the other one of the first substrate and the second substrate, and having an alignment direction parallel to the row direction.
